(19) United States
(12) Patent Application Publication
(10) Pub. No.: US 2015/0019425 A1
(43) Pub. Date: Jan. 15, 2015

(54) METHODS AND DEVICES FOR FRAUD DETECTION DURING MOBILE PAYMENT

(71) Applicant: Rogers Communications Inc., Toronto (CA)

(72) Inventors: Vinay KUMAR, Brampton (CA); Jeppe DORFF, Toronto (CA)

(21) Appl. No.: 13/938,386

(22) Filed: Jul. 10, 2013

(51) Int. Cl. G06Q 20/40

(52) U.S. Cl. CPC G06Q 20/4016
USPC 705/44

(57) ABSTRACT

Methods, devices and servers for assisting a financial institution server in identifying a fraudulent financial transaction initiated via an electronic device are described. In one aspect, a method for verifying security information associated with an electronic device during a financial transaction between the electronic device and the financial institution server is described. The method is implemented by the financial institution server. The method includes: sending a request for security information associated with the electronic device to a wireless service provider server, the request including a phone number associated with the electronic device; receiving the security information from the wireless service provider server, the security information including at least a unique equipment identifier associated with the phone number or an operating state of the electronic device; and determining whether the financial transaction is authorized based on the received security information.

### TECHNICAL FIELD

The present disclosure relates generally to systems for detecting and preventing a fraudulent financial transaction. More specifically, it relates to methods and devices for assisting a financial institution server in identifying a fraudulent financial transaction initiated via an electronic device.

### BACKGROUND

Electronic devices, such as smartphones or tablets, may be capable of initiating and performing mobile payments. By providing such capabilities, a user may use the electronic device to make purchases of goods and services, instead of paying by cash, cheque or a traditional credit card. In such cases, the electronic device may store financial instrument information (such as credit card information) on an associated SIM card, and this financial instrument information is provided to a merchant during a mobile payment transaction.

Unfortunately, financial transactions involving mobile payments are susceptible to fraudulent misuse. For example, the financial instrument information may be stolen and used to make a fraudulent purchase. In another example, the electronic device may be stolen, or the associated SIM card may be removed and placed into another electronic device belonging to a fraudster. The fraudster may fraudulently perform an unauthorized mobile payment with the stolen electronic device and/or SIM card. To safeguard against fraudulent misuse, financial institutions that manage the issued financial instrument, have adopted various security protocols.

In some cases, the financial institution may consider patterns of usage of the financial instrument in order to detect fraudulent use. For example, if the amount of purchase, location of purchase, merchant type, etc. are unexpected, the financial institution may trigger further inspection of that transaction prior to approving it or prevent the financial transaction from occurring. This pattern-based validation procedure may help to prevent fraud, but also sometimes causes the financial transaction to be erroneously declined or erroneously approved.

### BRIEF DESCRIPTION OF THE DRAWINGS

Reference will now be made, by way of example, to the accompanying drawings which show an embodiment of the present application, and in which:

FIG. 1 shows a block diagram illustrating an example communication system in which example embodiments of the present disclosure may operate;

FIG. 2 shows a block diagram of an example financial institution server in accordance with example embodiments of the present disclosure;

FIG. 3 shows a block diagram of an example wireless service provider server in accordance with example embodiments of the present disclosure;

FIG. 4 shows a block diagram of an example electronic device in accordance with example embodiments of the present disclosure;

FIG. 5 shows a flowchart of an example method of verifying a mobile payment transaction; and

FIG. 6 shows a flowchart of an example method of determining whether to authorize the mobile payment transaction.

Similar reference numerals are used in different figures to denote similar components.

### DETAILED DESCRIPTION OF EXAMPLE EMBODIMENTS

In one aspect, a method for verifying security information associated with an electronic device during a financial transaction between the electronic device and the financial institution server is described. The method is implemented by the financial institution server. The method includes: sending a request for security information associated with the electronic device to a wireless service provider server, the request including a phone number associated with the electronic device; receiving the security information from the wireless service provider server, the security information including at least a unique equipment identifier associated with the phone number or an operating state of the electronic device; and determining whether the financial transaction is authorized based on the received security information.

In another aspect, a financial institution server for verifying security information associated with an electronic device during a financial transaction between the electronic device and the financial institution server is provided. The financial institution server includes a communication subsystem and a memory. The financial institution server also includes a processor coupled to the communication subsystem and the memory. The processor is configured to: send a request for security information associated with the electronic device to a wireless service provider server, the request includes a phone number associated with the electronic device; receive the security information from the wireless service provider server, the security information includes at least a unique equipment identifier associated with the phone number or an operating state of the electronic device; and determine whether the financial transaction is authorized based on the received security information.

In yet another aspect, a method for providing security information associated with an electronic device during a financial transaction between the electronic device and the financial institution server is described. The method is implemented by a wireless service provider server. The method includes: receiving a request, from the financial institution server, for security information associated with the electronic device, the request including a phone number associated with the electronic device; in response to receiving the request, determining the security information based on the phone number associated with the electronic device, the security information including at least a unique equipment identifier associated with the phone number or an operating state of the electronic device; and sending the security information to the financial institution server.

In yet another aspect, a wireless service provider server for providing security information associated with an electronic device during a financial transaction between the electronic device and the financial institution server is provided. The wireless service provider server includes a processor. The processor is configured to: receive a request, from the financial institution server, for security information associated with the electronic device, the request includes a phone number associated with the electronic device; in response to receiving the request, determine the security information based on the phone number associated with the electronic device, the security information includes at least a unique equipment identifier associated with the phone number or an operating state of the electronic device; and send the security information to the financial institution server.

In yet another aspect, a non-transitory computer readable medium is described. The non-transitory computer readable medium includes instructions for performing a method described herein.

Other aspects and features of the present application will become apparent to those ordinarily skilled in the art upon review of the following description of specific embodiments of the application in conjunction with the accompanying figures.

### Example Communication System

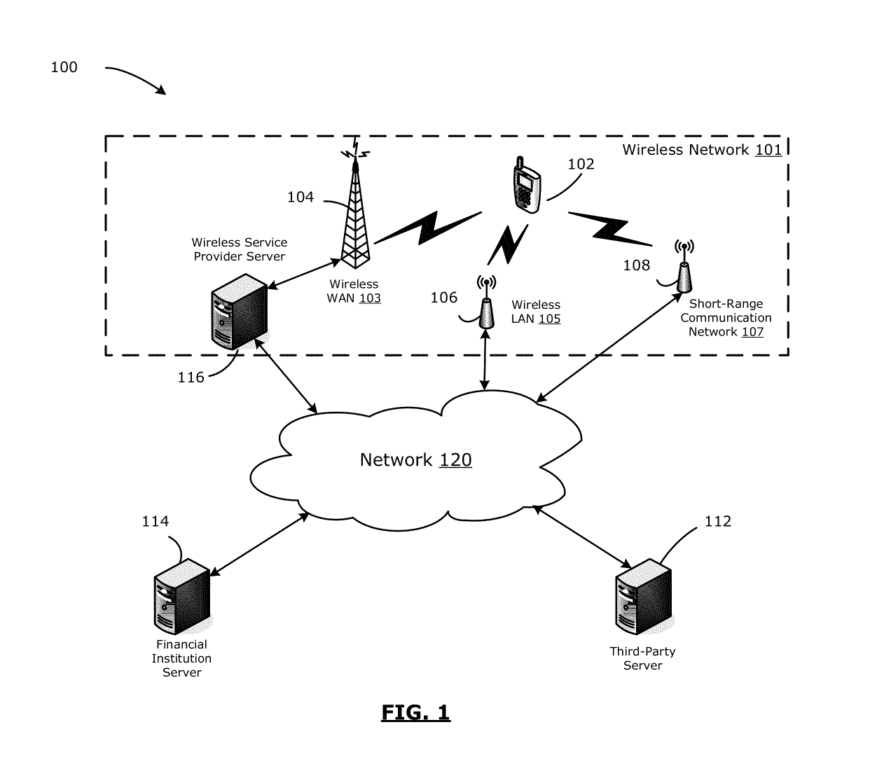

Reference is first made to FIG. 1, which illustrates in block diagram form a communication system 100 in which example embodiments of the present disclosure may operate.

In the embodiment of FIG. 1, an electronic device 102 is illustrated. More specifically, the electronic device 102 is a mobile communication device, such as a smartphone or tablet. The electronic device 102 may be capable of data communications, or both voice and data communications. The mobile communication device may communicate with other electronic devices, servers and/or systems connected with the communication system 100.

Accordingly, In at least some example embodiments, the electronic device 102 is connected for communication via a wireless network 101 which may include one or more of a Wireless Wide Area Network (WWAN) 103, a Wireless Local Area Network (WLAN) 105, a short-range communication network 107, other network arrangements, and/or a combination of these networks. In at least some example embodiments, the electronic device 102 is configured to communicate over both the WWAN 103 and the WLAN 105, and may roam between these two networks.

The WWAN 103 is commonly referred to as a “cellular network”, and may include a number of transceiver base stations 104 (with one being shown in FIG. 1). A transceiver base station 104 provides wireless radio frequency coverage for a corresponding area or cell, in order to facilitate wireless communication for the electronic device 102.

The WWAN 103 may be operated by one or more wireless service providers that provide the communication services necessary for the electronic device 102 to connect to the WWAN 103. The WWAN 103 may conform to various network types (such as, GSM, GPRS, LTE, TDMA, CDMA, etc.), and may support a number of frequency bands for communications within a particular wireless network type (for example, in the GSM network, the transceiver base station may support four frequency bands: 850/900/1800/1900 MHz). The WWAN 103 via a transceiver base station 104 provides a number of channels within a frequency band to allow the electronic device 102 to communicate. That is, the transceiver base station 104 assigns an available channel to the electronic device 102 to establish a communication link within the WWAN 103.

In the illustrated example of FIG. 1, within the WWAN 103, a transceiver base station 104 is connected to a wireless service provider server 116. The wireless service provider server 116 is operated by a wireless service provider and may provide specific functions and features for the wireless service provider. A wireless service provider is a provider of communication services to the electronic device 102, and may be referred to as a mobile network operator (MNO). The wireless service provider may own or control all the elements necessary to sell and deliver communication services to the electronic device 102. For example, the wireless service provider may own or control the wireless network infrastructure (which includes the transceiver base stations 104 and the wireless service provider servers 116), back haul infrastructure, provisioning, billing and customer care computer systems, marketing, engineering and repair organizations, etc. These elements are required in delivering and managing wireless communication services to end-users of electronic devices 102. Examples of wireless service providers include Rogers Wireless™, Telus Mobility™, Verizon Wireless™, AT&T Mobility™, etc.

It will be appreciated that some of the functions of the “wireless service provider server 116” may, in some embodiments, be provided on a server that is not owned or operated by the wireless service provider. For example, in at least some embodiments, a third-party may operate a server that is configured to perform some or all functions of the wireless service provider server 116 discussed herein. For example, in some embodiments, a Mobile Virtual Network Operator (MVNO) may own and/or operate some components of a wireless network such as, for example, a server that is configured to perform some or all of the functions of the wireless service provider server 116 described in this document. Wireless access may be a subscription-based service. That is, in order for the electronic device 102 to obtain communication services, the electronic device 102 may need to subscribe to a wireless service provider. Such subscription services may be pre-paid (which is commonly referred to as “pay as you go”) or may be post-paid subscription services. The wireless service provider provides subscription services in the form of a subscription service package that is purchased by end-users of the electronic devices 102 in order to enable the electronic devices 102 for communication on the wireless network 101. The subscription service package defines the terms of usage of the subscription services such as amount of voice and data communications, number and type of voice and data communications, rates of voice and data communications, etc.

A purchased subscription service package is typically associated with a subscriber identity module (SIM) provided by a wireless service provider. The SIM may, in some embodiments, be a “virtual SIM”, which consists of a phone number provided by a MNO that does not require a SIM card to connect to a network. In some embodiments, the SIM may be provided as a physical element referred to as a “SIM card” (which may also be referred to as a universal integrated circuit card (UICC)). The SIM card may be removably inserted within the electronic device 102. The SIM stores unique identifiers (such as a phone number and an international mobile subscriber identity (IMSI)) and associated security keys that are allocated by the wireless service provider, in order to identify and authenticate subscribers on the wireless network 101.

When an end-user purchases a subscription service package from a wireless service provider, the end-user is subscribed to the wireless service provider. The wireless service provider may maintain and/or have access to identifying information associated with the end-user in order to define a profile for the end-user. The identifying information may include personal information (such as, a name, address, email address, etc.), SIM identifying information (i.e. the IMSI and phone number) and/or electronic device information that are all associated with the end-user (for example, the International Mobile Station Equipment Identity (IMEI)).

The electronic device information may include identifiers and characteristics of the electronic device 102 in which the associated SIM card of the end-user is operating. For example, in at least some example embodiments, the electronic device information may include a unique equipment identifier (such as, an international mobile station equipment identity (IMEI) of the electronic device—which is a unique number allocated to an electronic device 102 in order to identify the electronic device 102), an operating state of the electronic device 102 (such as, whether the electronic device 102 is in a currently switched-on state or a currently switched-off state), whether the electronic device 102 is on a national equipment identity register (EIR) (i.e. whether the device is backlisted), a roaming status of the electronic device 102, etc.

It will be appreciated that the identifying information of an end-user may continuously change and be updated by the wireless service provider. Personal information, SIM identifying information and/or electronic device information may all change. For example, personal information such as an address may change when the end-user changes his/her residential address and informs the wireless service provider. SIM identifying information such as the phone number may change when a user requests the wireless service provider to change his/her phone number. Electronic device information, such as the IMEI, may change when the user decides to change electronic devices and switches the SIM card from one electronic device to another electronic device.

Such identifying information defining a profile of an end-user may be used for various purposes by the wireless service provider. For example, in at least some example embodiments, the identifying information may be used for security related purposes. In such cases, some or all of the identifying information may be included as part of “security information”, and this security information may be used by the wireless service provider server 116 and/or other servers for verification purposes of the end-user. For example, as will be discussed in greater detail below, in some example embodiments, the wireless service provider may provide the security information to a financial institution which uses the security information to determine whether to authorize a mobile payment for an end-user.

The WLAN 105, as part of the wireless network 101, may be a personal network of the end-user, an enterprise network, or a hotspot offered by a wireless service provider, or a property owner in a public or semi-public area. In such cases, the electronic device 102 may connect with the WLAN 105 via access points 106 that conform to various protocols such as Wi-Fi, WiMAX, etc.

Additionally, the wireless network 101 may include one or more short-range communication networks 107. The short-range communication networks 107 provide short-range protocols of communications for the electronic device 102, such as over a Near-Field Communications (NFC) protocol or Bluetooth™ Communications protocol. For example, as illustrated in FIG. 1, the short-range communication network 107 may include a point of sale (POS) terminal 108. The POS terminal 108 is typically owned by a merchant, and is a point where a financial transaction for the purchase of goods and services may be performed. The POS terminal 108 may provide a short-range communication protocol (such as, NFC) in order to allow for communication with the electronic device 102 to perform a mobile payment transaction. For example, an end-user making a purchase, may communicate with the POS terminal 108 via a short range communication subsystem of the electronic device 102 to provide financial instrument information to a back-end server connected to the POS terminal (the back-end server is illustrated as a “third-party server 112”). The back-end server which may be operated by the merchant or a third-party may communicate with a financial institution server 114 to obtain payment for the purchase by the end-user.

Thus, in at least some embodiments, a financial transaction between the electronic device 102 and the third-party server 112 may be initiated over the short-range communication network 107. For example, the electronic device 102 may be brought within the vicinity of the POS terminal 108, thereby initiating the transaction. In some embodiments, financial transactions may also be initiated over one or more of the other wireless networks instead of or in addition to the short-range communication network 107. For example, a financial transaction may be initiated over the wireless WAN 103 and/or the wireless LAN 105. By way of example, in some embodiments, the third-party server may be an e-commerce server. The e-commerce server may, for example, be accessible over the Internet. For example, the e-commerce server may be a retail website.

As illustrated, the devices and servers may connect and communicate with one another via a network 120. The network 120 may be a public network or a private network, or a combination thereof, and may include the internet. For example, the POS terminal 108 and/or the third party server 112 may interact with a financial institution server 114 to process a financial transaction. The financial institution server may inform the POS terminal 108 and/or the third party server whether the transaction is approved or declined.

The financial institution server 114 is operated by a financial institution (such as, a bank). The financial institution may provide financial instruments (such as credit cards, debit cards, checks, etc.) to an end-user of the electronic device 102. Accordingly, in at least some example embodiments, the financial institution server 114 may manage the financial instruments for financial transactions. In some cases, the financial institution server 114 may manage mobile payments from the electronic device 102. For example, the electronic device 102 may store financial instrument information (such as credit card information) on the SIM card or in a separate area of the electronic device 102 (such, as a storage area or a secure exchange manager). During a mobile payment transaction, this financial instrument information is communicated to the third-party server 112 (i.e. a merchant's server) from the electronic device 102 via the POS terminal 108 (and/or via another connection to the third-party server 112 e.g. via the WWAN 103 or WWLAN 105), and the third-party server 112 communicates with the financial institution server 114 to obtain payment. In such cases, the financial institution server 114 may manage security features by declining certain financial transactions. For example, the financial institution server 114 may decline certain mobile payment transactions if the transaction has certain unexpected features (such as, for an unexpected amount and/or merchant, occurring from an unexpected location, etc.).

Additionally, in at least some example embodiments, the financial institution server 114 may manage security features associated with mobile payment transactions using additional or other criteria. More particularly, such criteria may be based on the characteristics of the electronic device 102 from which the mobile payment originates. In such cases, the financial institution server 114 may implement security features to detect mobile payment transactions originating from unauthorized electronic devices 102 and identify these transactions for further scrutiny. For example, in at least some example embodiments, during a mobile payment transaction between an electronic device 102 via a POS terminal 108 (and/or via another connection to the third-party server 112 e.g. via the WWAN 103 or WWLAN 105), the financial institution server 114 may send a request for security information associated with the electronic device 102 to the wireless service provider server 116. The request may include the phone number associated with the electronic device 102 (in such cases, the financial institution server 114 may initially obtain the phone number from the electronic device 102 e.g. via the POS terminal 108 and/or the third-party server 112). The financial institution server 114 may then receive the security information from the wireless service provider server 116. The security information may include at least a unique equipment identifier (such as, an IMEI uniquely identifying the device currently associated with the phone number) associated with the phone number or an operating state of the electronic device 102 (for example, information indicating whether the electronic device 102 is currently switched on or switched off). The financial institution server 114 then determines whether to authorize the mobile payment transaction based on the received security information.

As mentioned above, in at least some example embodiments, the mobile payment transaction may be over the WWAN 103 or WWLAN 105 (via the internet) to connect to a third-party server 112 that may be an e-commerce server. Such a mobile payment transaction may be referred to as a mobile web payment transaction in which the electronic device 102 accesses a website (i.e. a “retail” website) provided by the third-party server 112 in order to purchase associated products and services (websites that allow for mobile web payment transactions include Amazon™, eBay™, etc.). In such cases, financial instrument information (such as, credit card information) is obtained by the third-party server 112 via the website, as well as identifying information associated with the electronic device 102 (such as, the phone number and/or IMEI associated with the electronic device 102). The obtained financial instrument information and identifying information is then sent to the financial institution server 114, and the financial institution server 114 may subsequently perform a similar verification process as described above based on the received information, to determine whether to authorize the financial transaction (for example, by requesting, receiving and analyzing security information obtained from the wireless service provider server 116).

The determination process for determining whether to authorize the transaction may be performed according to various methods. For example, in some embodiments, a check may be performed to determine whether the specific electronic device that is being used to perform a financial transaction is one that is expected to be used with the phone number that the electronic device purports to be associated with. More specifically, in at least some example embodiments, the financial institution server 114 may store one or more historical unique equipment identifiers associated with a phone number. In such cases, the financial institution server 114 may maintain a database which identifies all electronic devices that have previously been associated with a particular phone number. The database may, in at least some embodiments, identify the electronic devices that have been previously authorized to perform a mobile payment transaction using the particular phone number. For example, the database may associate phone numbers with historical unique equipment identifiers (such as IMEIs) identifying one or more electronic devices previously used with that phone number and which were previously authorized to perform a financial transaction from an electronic device associated with that phone number. In such example embodiments, the financial institution server 114, in determining whether the financial transaction is authorized, may determine whether the received unique equipment identifier from the wireless service provider server corresponds to one of the stored one or more historical unique equipment identifiers associated devices. If there is match between the received unique equipment identifier and one of the stored one or more historical unique equipment identifiers, the mobile payment transaction may be authorized. That is, since the electronic device 102 was previously used for performing mobile payment and since the electronic device 102 was (at the time of the prior mobile payment) associated with the same phone number which it is currently being used with, the mobile payment is allowed to proceed by the financial institution server 114. If, however, the electronic device 102 was not previously used in associated with the phone number for performing a mobile payment, then the financial institution server 114 may either decline the transaction or may require a further verification process to be performed before allowing the transaction. This method of determining whether a financial transaction will be authorized may, for example, prevent a fraudster from completing a transaction by physically placing a removable SIM card into an unauthorized device (e.g. unbeknownst to the owner of the SIM card) and/or by spoofing a SIM card on the unauthorized device.

In at least some example embodiments, the financial institution server 114 may rely on other information in order to determine whether to authorize the mobile payment transaction (i.e. apart from the historical unique equipment identifies). For example, in some embodiments, the determination of whether to authorize the financial transaction will depend on whether the electronic device being used to complete the transaction and the phone number that is reported (by the electronic device) as being attached to that electronic device is registered in the wireless service provider server 116 for use with that phone number. The wireless service provider server 116 may, for example, maintain a record specifying which electronic devices are associated with which phone numbers. This information may be provided to the wireless service provider server as part of a registration process which occurs when a SIM card is placed into an electronic device and the electronic device is registered in the network. More particularly, when this happens, the electronic device may report its phone number (i.e. the phone number associated with the SIM card) and its unique equipment identifier, which may then be recorded by the wireless service provider server 116 (i.e. saved in memory).

In such example embodiments, the financial institution server 114 may, during the financial transaction, obtain a unique equipment identifier associated with the electronic device 102 from the electronic device 102 along with a phone number associated with the SIM installed on that electronic device 102. Then, when determining whether the financial transaction is authorized, the financial institution server 114 may determine whether the obtained unique equipment identifier associated with the electronic device 102 from the electronic device 102 corresponds to a received unique equipment identifier from the wireless service provider server 116. That is, the phone number may be provided to the wireless service provider server 116 and the wireless service provider server 116 may, in response, provide the financial institution server 114 with the unique equipment identifier identifying the electronic device 102 currently in use in association with the specified phone number (i.e. the electronic device which is registered with the wireless service provider server for use with that phone number). If there is a match between the obtained unique equipment identifier received from the electronic device 102 and the unique equipment identifier received from the wireless service provider server 116, then mobile payment transaction may be authorized. If, however, there is no match, then the financial institution server 114 may either decline the transaction or may require a further verification process to be performed before allowing the transaction. This method of determining whether a financial transaction will be authorized may, for example, prevent a fraudster from completing a transaction by spoofing a SIM card on the unauthorized device.

While the examples above have generally referred to embodiments in which a comparison is performed on the financial institution server (e.g. between the unique equipment identifier received from the wireless service provider server and the unique equipment identifier received directly from the electronic device), in at least some example embodiments, the financial institution server 114 may not perform the comparison features, and may instead rely on the wireless service provider server 116 to do so. For example, the wireless service provider server 116 may perform the comparison and then provide verifying information to the financial institution server from which the financial institution server 114 may determine whether to authorize the mobile payment transaction. In such cases, the financial institution server 114 may obtain a unique equipment identifier associated with the electronic device 102 from the electronic device 102, and send the obtained unique equipment identifier associated with the electronic device 102 to the wireless service provider server 116. The wireless service provider server 116 then performs a comparison process by determining whether the received unique equipment identifier associated with electronic device corresponds to either a unique equipment identifier directly obtained from the electronic device 102 by the wireless service provider server 116, or one or more historical unique equipment identifiers associated with the phone number of the electronic device 102 that are stored by the wireless service provider server 116. Verifying information is then created indicating whether there is or is not a match, and this verifying information is then sent to the financial institution server 114. The financial institution server 114 may then use this information to determine whether to authorize the mobile payment transaction (i.e. if there is a match, then the mobile payment transaction is authorized).

Accordingly, as the SIM card which includes a particular phone number may be switched from one electronic device to another electronic device, the electronic device 102 is verified prior to the financial institution server 114 authorizing the mobile payment transaction.

In at least some example embodiments, in situations where there is no correspondence between unique equipment identifiers (e.g. where the unique equipment identifier received directly from the electronic device 102 by the financial institution server does not match the historical unique equipment identifiers associated with phone number received from the electronic device and/or does not match the unique equipment identifier which the wireless service provider server 116 currently associates with the phone number), the financial institution server 114 may request further verification from the electronic device 102. In such cases, verification of the electronic device 102 may need to be provided by the end-user in order to authenticate the electronic device 102 and allow the mobile payment transaction to proceed. For example, the financial institution server 114 may send a request for verification to the electronic device 102. The request for verification may include one or more security questions, a password prompt (or a pin prompt) and/or other types of requests. Upon receipt, the electronic device 102 may display the security question and/or the password prompt. The financial institution server 114 may then receive a response to the request for verification from the electronic device 102. For example, an end-user may input an answer to a displayed security question and/or a password to a password prompt, and the answer and/or password are sent to the financial institution server 114 from the electronic device 102. The financial institution server 114 then determines whether the received response corresponds to a key associated with the request for verification (for example, whether there is match between the submitted answer and an answer key for the question, and/or between the submitted password and a password key for the password). If there is a match between the received response and the key associated with the request for verification, the mobile payment transaction is authorized. However, if there is no match, the mobile payment transaction may be declined.

In such example embodiments, where the electronic device 102 has been further verified by the financial institution server 114, and in cases where the financial institution server 114 stores one or more historical unique equipment identifiers associated with the phone number of the electronic device 102, the financial institution server 114 may store the received unique equipment identifier from the wireless service provider server 116 in association with the phone number received from the electronic device 102. As such, the financial institution server 114, may update the database of the historical unique equipment identifier(s) that are associated with a phone number so that future mobile payments occurring from the electronic device 102 with that phone number will be authorized without requesting further verification.

As mentioned above, in at least some example embodiments, during a mobile payment transaction, the financial institution server 114 may receive, from the wireless security provider server 116, security information that defines an operating state of the electronic device 102 (i.e. the current operating state for that electronic device 102). More particularly, the financial institution server 114 may send a request to the wireless service provider server 116 which effectively asks the wireless service provider server 116 to inform the financial institution server 114 of the operating state of an electronic device associated with a phone number and/or a unique equipment identifier for an electronic device 102 which is currently attempting to perform a financial transaction. In response, the wireless service provider server 116 determines the operating state and provides it to the financial institution server 114.

The operating state of the electronic device 102 may be a currently switched-on state or a currently switched-off state. The operating state of the electronic device 102 may be determined by the wireless service provider server 116 sending a short message service (SMS) communication to the electronic device 102, and in response, the wireless service provider server 116 determines whether a delivery notification associated with the SMS is received within a pre-determined time from the electronic device 102. If the delivery notification is received within the pre-determined time, the operating state is a currently switched-on state of the electronic device 102; however, if the delivery notification is not received within the pre-determined time, the operating state is a currently switched-off state of the electronic device 102.

As noted above, the operating state of the electronic device 102 is provided to the financial institution server 114, which uses this information to determine whether a financial transaction will be permitted to be performed. More specifically, the financial institution server 114 authorizes the mobile payment transaction when the operating state defines a currently switched-on state of the electronic device 102; while, the financial institution server 114 may decline the mobile payment transaction when the operating state defines a currently switched-off state of the electronic device 102. In such a manner, the financial institution server 114 may verify the operating status of the electronic device 102, and reduce fraudulent mobile payments caused by unique equipment identifier spoofing and/or phone number spoofing (also known as SIM spoofing). That is, when an electronic device 102 attempts to perform a financial transaction and that electronic device 102 purports to be associated with a phone number (and/or unique equipment identifier) which is currently assigned to an electronic device 102 which is, in fact, switched-off, the financial transaction is declined.

In at least some example embodiments, during a mobile payment transaction, the financial institution server 114 may receive security information, from the wireless service provider server 116, that includes information indicating whether the electronic device 102 is blacklisted (i.e. whether the electronic device 102 has been reported as lost or stolen and listed on a national EIR database). In such cases, the wireless service provider server 116 may have access to other national EIR databases that may be created by foreign wireless service providers servicing international regions (for example, EIR databases of U.S., Canada, Europe, etc.). More particularly, the wireless service provider server 116 may have access to national EIR databases of foreign wireless service providers with which it has roaming agreements. In such cases, an electronic device 102 that is subscribed with a foreign and international wireless service provider and which enters the region of coverage of the wireless service provider may be roaming (as the electronic device 102 is outside of its home network). Accordingly, in such example embodiments, the wireless service provider server 116 may obtain the unique equipment identifier of the roaming electronic device 102 (e.g. from the financial institution server, which may obtain it from the electronic device 102 via the POS terminal 108 and/or the third-party sever 112) and determine whether the unique equipment identifier of the roaming electronic device 102 is listed in the national EIR database that is provided by the foreign and international wireless service provider. Security information sent may then be sent from the wireless service provider server 116 to the financial institution server 114 which indicates whether this roaming electronic device 102 is blacklisted or not. The financial institution server 114 may decline the mobile payment transaction if the security information indicates that the roaming electronic device 102 is blacklisted.

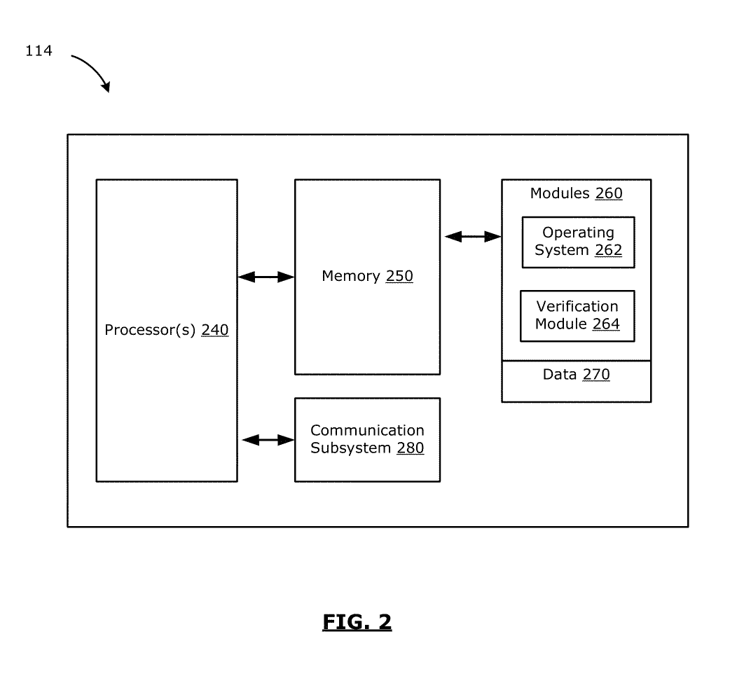

Example components and features of the financial institution server 114, the wireless service provider server 116 and the electronic device 102 will be discussed in greater detail below with reference to FIGS. 2, 3 and 4 respectively.

It will also be appreciated that the above-described communication system 100 is provided for the purpose of illustration only, and that the above-described communication system 100 includes one possible communication network configuration of a multitude of possible configurations.

For example, while the wireless service provider server 116 is illustrated as a single component, in practice it may be constructed of a number of components which may be physically separated from one another.

### Example Financial Institution Server

Reference is next made to FIG. 2 which illustrates an example financial institution server 114 in block diagram form. Although the financial institution server 114 is shown to be implemented as a single server, it will be understood that the functions of the financial institution server 114 may be implemented across a multitude of network servers, or other suitable architecture.

In at least some embodiments, the functions of the financial institution server 114 may be implemented, in whole or in part, by way of a processor 240 which is configured to execute software modules 260 stored in memory 250. In the embodiment of FIG. 2, the financial institution server 114 includes a controller comprising one or more processors 240 which control the overall operation of the financial institution server 114. The processor 240 interacts with one or more communication subsystems 280 to perform communication functions via the network 120, with other systems, servers and/or devices such as the electronic device 102, the wireless service provider server 116 and the third-party server 112. The communication subsystems 280 may, for example, include a subsystem that is configured to connect the financial institution server 114 with the third-party server 112 and/or the POS terminal 108. A communication subsystem 280 may also allow the financial institution server 114 to communicate with the wireless service provider server 116. In at least some embodiments, the communication subsystem 280 is configured for connecting the financial institution server 114 to a network 120, such as the Internet.

The financial institution server 114 also includes memory 250 which is connected to the processor 240 for receiving and sending data to the processor 240. While the memory 250 is illustrated as a single component, it will typically be comprised of multiple memory components of various types. For example, the memory 250 may include Random Access Memory (RAM), Read Only Memory (ROM), a Hard Disk Drive (HDD), Flash Memory, or other types of memory. It will be appreciated that each of the various memory types will be best suited for different purposes and applications.

The financial institution server may store data 270 in a data area of the memory 250. The data 270 may be of various types and may include service data, application data, user financial profile data, etc. The data 270 may be organized, at least partially, into a number of databases or data stores each containing data items of the same data type. For example, user financial profile data for a plurality of users may be stored in a common database and arranged accordingly within the database.

The processor 240 may operate under stored program control and may execute software modules 260 stored on the memory 250. The software modules 260 may be comprised of, for example, operating system software 262, and one or more additional modules such as a verification module 264 to carry out specific functions of the financial institution server 114.

In at least some example embodiments, the verification module 264 may manage a mobile payment transaction performed by the electronic device 102 by verifying associated security information and determining whether to authorize the transaction. For example, the verification module 264 may verify security information associated with an electronic device 102 (which may be obtained from the wireless service provider system 116) during a financial transaction between the electronic device 102 and the financial institution server 114 in order to determine whether to authorize the financial transaction.

In such example embodiments, the verification module 264 initially obtains a phone number associated with the electronic device 102 involved in the financial transaction. The phone number may be obtained in a variety of ways. For example, in at least some example embodiments, the verification module 264 may send a request for the phone number to the electronic device 102. In at least some example embodiments, the electronic device 102 may automatically send the associated phone number to the financial institution server 114 in response to receiving the request. However, in at least some example embodiments, further user input may be required to send the phone number in response to receiving the request. For example, the user may be required to provide confirmation (via an input interface associated with the electronic device 102) to send the requested phone number to the financial institution server 114. In some examples, the user may be queried to input the phone number and upon input, the phone number is sent to the financial institution server 114. In at least some example embodiments, the financial institution server 114 may not request the phone number from the electronic device 102, and instead the electronic device 102 may automatically send the phone number to the financial institution server 114 during initiation of the financial transaction.

After obtaining the phone number associated with the electronic device 102, the verification module 264 sends a request for security information associated with the electronic device 102 to the wireless service provider server 116. The request includes the phone number associated with the electronic device 102. In such cases, the electronic device 102 may be a subscriber of the wireless service provider that operates the wireless service provider server 116, and the wireless service provider server 116 maintains and/or has access to security information associated with the subscribed electronic device 102. The verification module 264 then receives the security information from the wireless service provider server 116 (i.e. in response to receiving the request, the wireless service provider server 116 retrieves and sends the associated security information). The security information may include a unique equipment identifier associated with the phone number (i.e. a unique equipment identifier of an electronic device currently in use with the phone number) or a current operating state of the electronic device 102. The verification module 264 then determines whether the financial transaction is authorized based on the received security information.

In at least some example embodiments, however, the wireless service provider that operates the wireless service provider server 116 which receives the phone number associated with the electronic device 102 from the verification module 264, may not be a subscriber for the electronic device 102. For example, the electronic device 102 may be roaming on the WWAN 103 provided by the wireless service provider. In such cases a roaming agreement may exist between the electronic device's 102 subscribed wireless service provider and the wireless service provider of the visiting network (i.e. WWAN 103), allowing the electronic device 102 to operate on the visiting network. In such example embodiments, the wireless service provider server 116 may not have direct access to some or all of the security information associated with the non-subscribed and roaming electronic device 102. Instead, the wireless service provider server 116 may perform the functions of a gateway server in which the wireless service provider server 116 may send the phone number to other servers, systems and/or devices to obtain the associated security information.

For example, in at least some example embodiments, the wireless service provider server 116 may receive and redirect the request (that includes the phone number associated with the electronic device 102) from the verification module 264 to another server operated by a wireless service provider that the electronic device 102 is subscribed to. In such example embodiments, this other server may maintain and/or have access to security information associated with the subscribed electronic device 102. This other server, in response to receiving the request from the wireless service provider server 116, may retrieve and send the associated security information to the wireless service provider server 116. The security information may similarly include a unique equipment identifier associated with the phone number or a current operating state of the electronic device 102. The wireless server provider server 116 then sends this received security information to the verification module 264. The verification module 264 then determines whether the financial transaction is authorized based on the security information.

In at least some example embodiments, the wireless service provider server 116 may not directly send the received request from the verification module 264 to the other server (i.e. the server that is operated by the wireless service provider that the electronic device 102 is subscribed to). Rather, a “central hub” may be present in the form a central server which acts as a further gateway to redirect communications between wireless service provider servers that are operated by different wireless service providers. More particularly, the wireless service provider server 116 may send the received request from the verification module 264 to this central server, and the central server may forward this request to the appropriate other server operated by the wireless service provider that the electronic device 102 is subscribed to. Similar to above, this other server may maintain and/or have access to security information associated with the subscribed electronic device 102. In response to receiving the request from the central server, this other server may retrieve and send the associated security information (which may include a unique equipment identifier associated with the phone number or a current operating state of the electronic device 102) back to the central server. The central server then sends this received security information to the wireless service provider server 116, and the wireless service provider resends this received security information from the central server to the verification module 264. The verification module 264 then determines whether the financial transaction is authorized based on the security information.

In at least some example embodiments, the determination of whether to authorize a financial transaction is based on the verification module 264 analyzing the received unique equipment identifier. As noted in the discussion of FIG. 1 above, in one such case, the financial institution server 114 may store one or more historical unique equipment identifiers associated with the phone number of the electronic device 102. For example, the one or more historical unique equipment identifiers may be stored in the data 270 area of memory 250. More particularly, the one or more historical unique equipment identifiers may be arranged in one or more data stores within the data 270 area of memory 250. More particularly, the data store may associate a phone number with the one or more historical unique equipment identifiers which were previously verified for use with that phone number.

In such cases, in determining whether the financial transaction is authorized, the verification module 264 may determine whether the received unique equipment identifier from the wireless service provider server 116 corresponds to one of the stored one or more historical unique equipment identifiers associated with the phone number received from the electronic device 102. That is, the verification module 264 may compare the received unique equipment identifier with the historical unique equipment identifier(s) associated with the particular phone number that are stored in the data 270 area of memory 250. For example, the verification module 264 may search and retrieve the historical unique equipment identifier(s) that are associated with the particular phone number from the data store, and compare these retrieved historical unique equipment identifier(s) with the received unique equipment identifier (which was received from the wireless service provider server).

In such example embodiments, the financial transaction is authorized when the received unique equipment identifier from the wireless service provider server 116 corresponds to one of the stored one or more historical unique equipment identifiers associated with the phone number that was received from the electronic device 102 attempting to perform the financial transaction. That is, if a match occurs between the received unique equipment identifier and one of the stored historical unique equipment identifier(s) for the phone number, then the financial transaction is authorized.

If however a match does not occur, in at least some example embodiments, the verification module 264 may perform further verification in order to determine whether to authorize the financial transaction. In such example, embodiments, the verification module 264, may send a request for verification of the electronic device 102 to the electronic device 102 when the received unique equipment identifier from the wireless service provider server 116 does not correspond to the one of the stored one or more historical unique equipment identifiers associated with the phone number of the electronic device 102. The request for verification may include one or more security questions and/or a password prompt associated with the phone number that relates to the end-user.

For example, the financial institution server 114 may store one or more security questions and/or a password prompt in the data 270 area of memory 250. More particularly, the one or more security questions and/or password prompt may be similarly arranged in data stores within the data 270 area of memory 250, with a data store storing one or more security questions and/or a password of an associated phone number that may relate to a user financial profile. These data stores may also store the associated key for the request for verification. For example, the key may be in the form of answers to the security questions and/or a password for the password prompt which may be stored in association with the security questions and/or the password prompt within a data store for a particular phone number. It will be appreciated that the particular phone number may be associated to a particular user, and the security questions and/or password prompt and associated answers and/or password respectively is information that the particular user may have initially selected during registration with the financial institution for issuance of the financial instrument for mobile payment.

In such cases, the verification module 264 may retrieve one or more of the security questions (which may be retrieved randomly) from the data 270 area, and send them to the electronic device 102 or may send a prompt to the electronic device 102 for input of a password. The verification module 264 may then receive a response to the request for verification from the electronic device 102 (for example, the electronic device 102 may display the security question and/or password prompt upon receipt, and an end-user may input a response to the security question and/or password prompt, and the response is subsequently sent to the financial institution server 114). The verification module 264 then determines whether the received response corresponds to a key associated with the request for verification. That is, the verification module 264 may compare the received response with an associated key that is stored in the data 270 area of memory 250. For example, the verification module 264 may retrieve the answer(s) to the sent one or more questions and/or retrieve the password to the sent password prompt, and compare these retrieved answer(s) and/or password with the received response.

In such example embodiments, the financial transaction is authorized when the response corresponds to the key associated with the request for verification. That is, if the response matches the answers of the sent one or more security questions and/or password of the sent password prompt, the financial transaction is authorized. However, if no match occurs, then the financial transaction may be declined.

In at least some example embodiments, the verification module 264 may store the received unique equipment identifier from the wireless service provider server 116 in association with the stored one or more historical unique equipment identifiers associated with the phone number of the electronic device 102 when the received response corresponds to the key associated with the request for verification. That is, as the electronic device 102 has been verified, the associated unique equipment identifier is included with the historical one or more unique equipment identifiers associated with the phone number received from the electronic device 102 so that future financial transactions from the electronic device 102 with the associated phone number do not require further verification.

In another case in which the determination of whether to authorize the financial transaction is based on the verification module 264 analyzing the received unique equipment identifier, the verification module 264 may obtain a unique equipment identifier associated with the electronic device 102 from the electronic device 102. The associated unique equipment identifier may be obtained in a variety of ways. For example, in at least some example embodiments, the verification module 264 may send a request for the associated unique equipment identifier to the electronic device 102. In such example embodiments, the electronic device 102 may send its unique equipment identifier upon receiving the request. In at least some example embodiments, the electronic device 102 may automatically send its unique equipment identifier without receiving a request from the electronic device 102. For example, the electronic device 102 may send its unique equipment identifier during initiation of the financial transaction.

In such cases, in determining whether the financial transaction is authorized, the verification module 264 may determine whether the obtained associated unique equipment identifier from the electronic device corresponds to the received unique equipment identifier from the wireless service provider server 116. That is, the verification module 264 may compare the unique equipment identifier associated with the electronic device obtained from the electronic device 102 with the received unique equipment identifier from the wireless service provider server 116 to determine whether there is a match between the two.

In such example embodiments, the financial transaction is authorized when the obtained unique equipment identifier associated with the electronic device 102 from the electronic device 102 corresponds to the received unique equipment identifier from the wireless service provider server 116. That is, if a match occurs between the two unique equipment identifiers, the financial transaction is authorized.

Similar to above, if however a match does not occur, in at least some example embodiments, the verification module 264 may perform further verification in order to determine whether to authorize the financial transaction. For example, as mentioned above, the verification module 264, may send a request for verification (which may include one or more security questions and/or a password prompt) to the electronic device 102 when the obtained unique equipment identifier associated with the electronic device 102 from the electronic device 102 does not correspond to the received unique equipment identifier from the wireless service provider server 116. The verification module 264 may then receive a response to the request for verification from the electronic device 102 (for example, the electronic device 102 may display the one or more received security questions and/or password prompt upon receipt, and an end-user may input a response to the one or more security questions and/or password prompt that are subsequently sent to the financial institution server 114). The verification module 264 then determines whether the received response corresponds to a key associated with the request for verification. In such example embodiments, the financial transaction is authorized when the response corresponds to the key associated with the request for verification (i.e. if the response matches the answers of the sent one or more security questions and/or password of the sent password prompt, the financial transaction is authorized). However, if they do not correspond, then the financial transaction may be identified for further validation or declined. The key is, in at least some embodiments, user-specific. That is, it is a key associated with a user who is associated with the phone number.

Thus, in this embodiment, the financial institution server 114 determines whether the electronic device that is currently attempting to perform a financial transaction is, according to the wireless service provider server, in fact currently associated with the phone number that was provided to the financial institution server 114 by the electronic device 102. If the financial institution server receives, from the electronic device, a phone number and a unique equipment identifier but, according to the wireless service provider server 116, the phone number is currently in use with a device having a different unique equipment identifier, then the financial transaction may be fraudulent.

It will be appreciated that some of the steps or features which are described herein as being performed on the financial institution server may instead be performed on the wireless service provider server. For example, an analysis may be performed by the wireless service provider server 116 based, in part, on information received from the financial institution server 114 and also on information known to the wireless service provider server 116 but not the financial institution server. The wireless service provider server 116 may generate verifying information indicating the result of the analysis. For example, in such example embodiments, the verification module 264 may obtain a unique equipment identifier associated with the electronic device 102 from the electronic device 102. The associated unique equipment identifier may be obtained by the verification module 264 in the same manner as already discussed above. The verification module 264 may then send the obtained unique equipment identifier associated with the electronic device 102 and the phone number received from the electronic device to the wireless service provider server 116, where the information is analyzed to determine whether the received phone number is, in fact, currently in use with an electronic device having the received unique equipment identifier (or whether the phone number is in use with an electronic device having a different unique equipment identifier). After receiving the verifying information which indicates the result of the analysis, the financial institution server may determine whether to authorize the financial transaction by analyzing the verifying information received from the wireless service provider server 116.

Accordingly, in at least some embodiments, the wireless service provider server 116 may compare the received unique equipment identifier from the verification module 264 (of the financial institution server) with the unique equipment identifier associated with the electronic device that is currently in use with the received phone number (this unique equipment identifier may be obtained directly from the electronic device 102 by the wireless service provider server 116) to determine whether there is a match or not. The wireless service provider server 116 then generates the verifying information indicating whether there is a match or not between the two unique equipment identifiers (i.e. the verifying information indicates whether the obtained unique equipment identifier associated with the electronic device 102 from the electronic device 102 corresponds to the unique equipment identifier associated with the phone number of the electronic device 102). This verifying information is sent and received by the verification module 264. In at least some example embodiments, this verifying information may be included as part of the sent security information that is received by the verification module 264. In such example embodiments, the verification module 264 analyzes the received verifying information. If the verifying information indicates a match between the two unique equipment identifiers, the financial transaction is authorized.

However, if the verifying information indicates that there is not a match between the two unique equipment identifiers, the verification module 264 may perform further verification in order to determine whether to authorize the financial transaction. Such verification may be performed in the same manner described above by sending a request for verification of the electronic device 102 to the electronic device 102; receiving a response to the request for verification from the electronic device 102; and determining whether the received response corresponds to a key associated with the request for verification. In such cases, the financial transaction is authorized if there is a match between the response and the key, while the financial transaction may be declined if there is not a match between the response and the key.

In at least some example embodiments, the determination of whether to authorize the financial transaction is based on the verification module 264 analyzing the operating state of the electronic device 102, as provided by the wireless service provider server 116. In such example embodiments, the security information received by the verification module 264 from the wireless service provider server 116 may include an operating state of the electronic device 102. The operating state may define the current operating state of the device and may be either a currently switched-on state or a currently switched-off state. That is, the wireless service provider server 116 obtains information as to the present operating state (i.e. whether the electronic device 102 is presently turned-on or turned-off) of the electronic device 102 having the phone number and/or unique equipment identifier specified by the financial institution server 114 and sends this information to the electronic device 102 as part of the security information. In such example embodiments, the verification module 264 analyzes the received operating state of the electronic device 102. If the operating state indicates that the electronic device 102 is currently switched-on, the financial transaction is authorized; while, if the operating state indicates that the electronic device 102 is switched-off, the financial transaction may be declined.

In at least some example embodiments, other modules, such as the operating system 262 may perform some or all of the functions of the verification module 264. In at least some example embodiments, the verification module 264 may instead include a plurality of software modules rather than a single block as illustrated.

It will be appreciated that the financial institution server 114 as illustrated in FIG. 2 is an example server. In at least some example embodiments, servers may be used which are of different configurations and/or functions.

### Example Wireless Service Provider Server

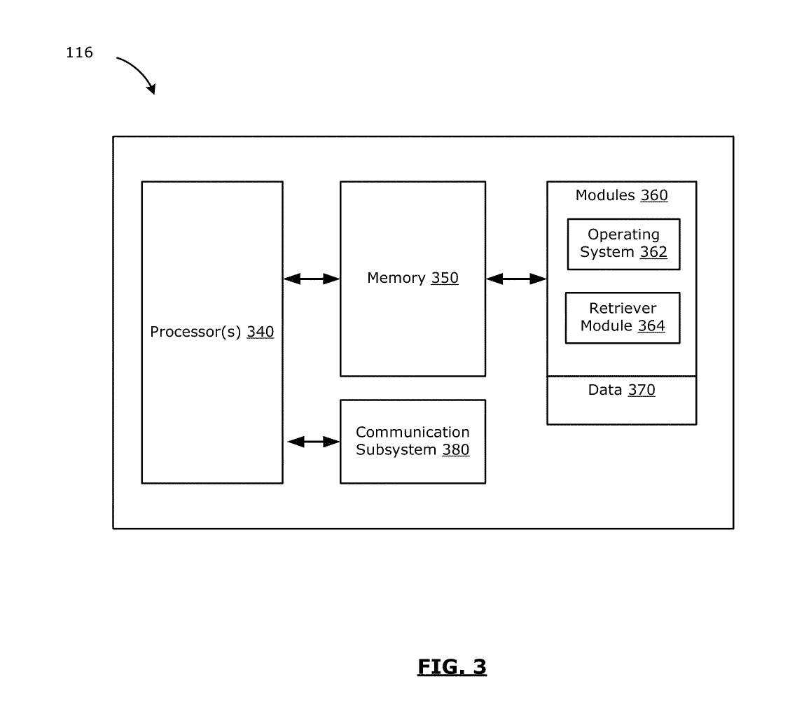

Reference is next made to FIG. 3 which illustrates an example wireless service provider server 116 in block diagram form. Although the wireless service provider server 116 is shown to be implemented as a single server, it will be understood that the functions of the wireless service provider server 116 may be implemented across a multitude of network servers, or other suitable architecture. Additionally, although the wireless service provider server 116 and the financial institution server 114 are configured to perform different functions, in at least some example embodiments, the wireless service provider server 116 may be of a similar configuration to the financial institution server 114.

In at least some example embodiments, the functions of the wireless service provider server 116 may be implemented, in whole or in part, by way of a processor 340 which is configured to execute software modules 360 stored in memory 350. In the embodiment of FIG. 3, wireless service provider server 116 includes a controller comprising one or more processors 340 which control the overall operation of the wireless service provider server 116. The processor 340 interacts with one or more communication subsystems 380 to perform communication functions via the wireless network 101 and/or network 120, with other systems, servers and/or devices such as the electronic device 102, the financial institution server 114 and the third-party server 112. More particularly, a communication subsystem allows the wireless service provider server 116 to communicate with one or more electronic devices 102 (e.g. via WWAN 103 and/or WLAN 105).

The wireless service provider server 116 also includes memory 350 which is connected to the processor 340 for receiving and sending data to the processor 340. While the memory 350 is illustrated as a single component, it will typically be comprised of multiple memory components of various types. For example, the memory 350 may include Random Access Memory (RAM), Read Only Memory (ROM), a Hard Disk Drive (HDD), Flash Memory, or other types of memory. It will be appreciated that each of the various memory types will be best suited for different purposes and applications.

The financial institution server may store data 370 in a data area of the memory 350. The data 370 may be of various types and may include service data, application data, subscriber profile data, etc. The data 370 may be organized, at least partially, into a number of databases or data stores each containing data items of the same data type. For example, subscriber profile data may be stored in the same database and arranged accordingly within the database.

The subscriber profile data may be obtained and stored within the data 370 area when an end-user is subscribed to the wireless service provider that operates the wireless service provider server 116. The subscriber profile data defines identifying information for a particular end-user (i.e. a subscriber). This identifying information may be obtained from the end-user and/or automatically obtained by the wireless service provider server 116. As mentioned above, the wireless identifying information may include personal information, SIM identifying and/or electronic device information that are associated with an end-user and/or an electronic device.

Personal information may include personal identifying information of the end-user such as a name, date of birth, address, email address, alternate phone, etc. Such personal information is obtained when the end-user purchases a subscription service package from the wireless service provider. In such cases, the wireless service provider directly collects the information from the end-user at the time of purchase of the subscription service package.

SIM identifying information may include a unique phone number and IMSI of the SIM card that is issued to the end-user. When a user purchases the subscription service package, the wireless service provider issues a SIM card for configuration on the end-user's electronic device 102 in order to enable communication services for the electronic device 102 on the wireless network 101. A SIM card includes a unique phone number and IMSI to identify the user on the wireless network 101.

The electronic device information includes identifiers and characteristics of the electronic device 102. For example, the electronic device information may include a unique equipment identifier of an electronic device 102 that is associated with the end-user, an operating state of the electronic device 102, whether the electronic device 102 is on an EIR, a roaming status of the electronic device 102, etc.

In at least some example embodiments, the unique equipment identifier may be an IMEI. The wireless service provider server 116 may obtain the IMEI of an electronic device 102 when the electronic device 102 is initially connected for communication on the wireless network 101. That is, when the end-user inserts the SIM card in the electronic device 102, the electronic device 102 sends the IMEI information to the wireless service provider server 116 during the initial registration of the SIM card for enabling the electronic device 102 to perform communication services. In such a manner, the wireless service provider server 116 may obtain the associated IMEI of an electronic device whenever the end-user switches the SIM card on to another electronic device. In such example embodiments, the wireless service provider server 116 may store multiple IMEIs for an end-user (i.e. the IMEIs for all the electronic devices for which a particular phone number has been used) or simply, the latest IMEI for an end-user (i.e. the IMEI of the electronic device that was last used with a particular phone number). Thus, the wireless service provider server 116 is able to identify the electronic device 102 currently in use with a particular phone number.

The operating state of the electronic device 102 is obtained by the wireless service provider server 116 by sending a SMS to the electronic device 102, and in response to sending the SMS, the wireless service provider server 116 determining whether a delivery notification associated with the SMS is received within a pre-determined time from the electronic device 102. If the delivery notification is received within the pre-determined time, the operating state is a currently switched-on state while if the delivery notification is not received within the pre-determined time, the operating state is a currently switched-off state.

As mentioned above, some or all of such identifying information of an end-user may be included as part of security information which may be stored in the data 370 area of memory 350. In at least some example embodiments, the security information may at least include a unique equipment identifier (such as, as an IMEI) of the electronic device 102 currently associated with the user (i.e. the electronic device 102 associated with the phone number assigned to the user) or an operating state of the electronic device 102. In at least some example embodiments, the security information may additionally include other information such as whether the electronic device 102 is on an EIR, whether the electronic device 102 is roaming, verifying information (which indicates an analysis of associated IMEIs), etc. Additionally, it will be appreciated that the security information may be arranged in any manner within the data 370 area of memory 350. For example, in at least some example embodiments, the security information is arranged such that each phone number is associated with one or more IMEIs of electronic devices (i.e. historical or latest IMEIs of electronic devices for which a particular phone number has been used).

It will be appreciated that in at least some example embodiments, this identifying information and/or security information may not be stored on the wireless service provider server 116. Instead this information may be stored on another device or server, and is accessible to the wireless service provider server 116.

The processor 340 may operate under stored program control and may execute software modules 360 stored on the memory 350. The software modules 360 may be comprised of, for example, operating system software 362, and one or more additional modules such as a retriever module 364 to carry out specific functions of the wireless service provider server 116.

In at least some example embodiments, the retriever module 364 may provide security information to the financial institution server 114 so that the financial institution server 114 may use the security information to determine whether to authorize a financial transaction (such as a mobile payment transaction) for an end-user.

In such example embodiments, during a financial transaction between the electronic device 102 and the financial institution server 114, the retriever module 364 may receive a request from the financial institution server 114 for security information associated with the electronic device. The request may include a phone number associated with the request. In response to receiving the request, the retriever module 364 may determine the security information based on the phone number. The security information may include a unique equipment identifier associated with the phone number or an operating state of the electronic device 102. For example, security information that is associated with the received phone number is retrieved or obtained from the electronic device 102. For example, the retriever module 364 may search the data 370 area of memory 350 for the particular phone number, and retrieve the security information associated with that phone number. Such security information retrieved may include a unique equipment identifier currently associated with the phone number (which may be an IMEI of an electronic device 102 for which the phone number was used, and which had been earlier retrieved and stored during registration of the electronic device 102) or an operating state of the electronic device 102. The retrieved security information is then sent by the retriever module 364 to the financial institution server 114, which is then used by the financial institution server 114 to determine whether to authorize the financial transaction.

In at least some example embodiments, the security information sent by the retriever module 364 may include verifying information which provides analysis of associated unique equipment identifiers. In such cases, the retriever module 364 may receive a unique equipment identifier associated with the electronic device 102 from the financial institution server 114. That is, the financial institution server 114 may directly obtain the associated unique equipment identifier of the electronic device 102 from the electronic device 102, and send the unique equipment identifier to the wireless service provider server 116. In such example embodiments, in determining the security information, the retriever module 364 determines whether the received unique equipment identifier associated with electronic device 102 from the financial institution server 114 (for example, the IMEI of the electronic device 102 that is obtained by the financial institution server 114 and sent to the wireless service provider server 116) corresponds to the unique equipment identifier associated with the phone number received from the financial institution server 114 (for example, the IMEI of the electronic device that was earlier received and stored during registration of the electronic device for which the phone number was used). That is, the retriever module 364 determines whether the two unique equipment identifiers match. The results of such analysis are subsequently included within the security information that is sent to the financial institution server 114. That is, the security information includes verifying information indicating whether the received unique equipment identifier associated with the electronic device 102 from the financial institution server 114 corresponds to the unique identifier associated with the phone number of the electronic device 102. As mentioned above, the financial institution server 114 then analyzes the received verifying information, and if the verifying information indicates a match between the two unique equipment identifiers, the financial transaction is authorized.

In at least some example embodiments, the wireless service provider server 116 may store one or more historical unique equipment identifiers associated with the phone number of the electronic device 102. For example, the wireless service provider server 116 may obtain and store the IMEIs (for example, in the data 370 area of memory 350) of all the electronic devices that have used the associated phone number. In such example embodiments, similar to above, the retriever module 364 may receive a unique equipment identifier associated with the electronic device 102 from the financial institution server 114 and a phone number. The retriever module 364 may, as part of determining the security information, determine whether the received unique equipment identifier associated with the electronic device 102 from the financial institution server 114 corresponds to one of the stored one or more historical unique equipment identifiers associated with the phone number received from the financial institution server 114. Similarly, the results of such an analysis are subsequently included within the security information that is sent to the financial institution server 114. That is, the security information includes verifying information indicating whether the received unique equipment identifier from the financial institution server 114 corresponds to one of the stored one or more historical unique equipment identifiers associated with the phone number received from the financial institution server 114. The financial institution server 114 then analyzes the received verifying information, and if the verifying information indicates a match between two unique equipment identifiers, the financial transaction is authorized.

In at least some example embodiments, other modules, such as the operating system 362 may perform some or all of the functions of the retriever module 364. In at least some example embodiments, the retriever module 364 may instead include a plurality of software modules rather than a single block as illustrated.

### Example Electronic Device

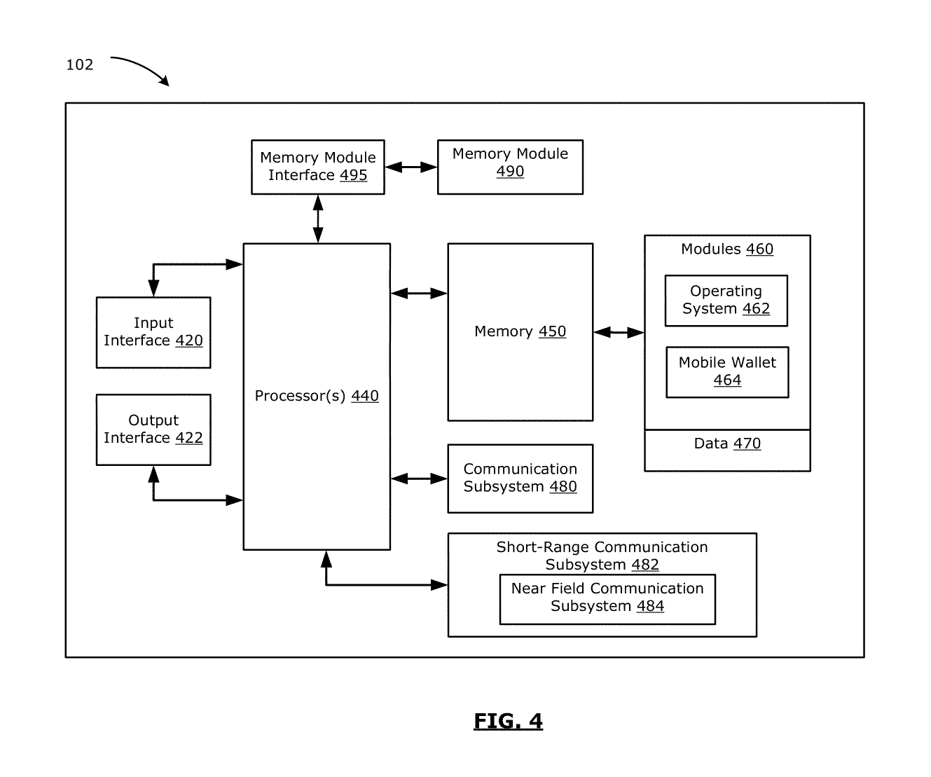

Reference is next made to FIG. 4 which illustrates an example electronic device 102 in block diagram form. In the illustrated example embodiments, the electronic device 102 is a mobile communication device (such as, a smartphone) capable of voice and data communications with other devices, systems and servers, for example, via the wireless network 101 and the network 120.

The electronic device 102 includes a controller which may include one or more processors 440 that control the overall operation of the electronic device 102. The processor 440 may be communicably coupled with device subsystems including one or more input interfaces 420 (such as a keyboard, control buttons, a microphone, a touchscreen display, a mouse, a trackpad, a microphone and/or other input interfaces), one or more output interfaces 422 (such as a display and/or a speaker), memory 450 (which may include multiple memory components of various types such as flash memory, random access memory (RAM), read only memory (ROM), a hard disk drive (HDD), a solid state drive (SSD), or other types of memory), a communication subsystem 480 for communicating wirelessly with other systems, servers and/or electronic devices via the wireless network 101 and/or network 120, and a short-range communication subsystem 482 (which may include a near field communication (NFC) subsystem 484 or Bluetooth™) for communicating over the short-range communication network 107 with, for example, a POS terminal 108. The processor 440 may be communicably coupled with other device subsystems not specifically described herein.

In at least some example embodiments, the electronic device 102 may also include one or more removable memory modules 490 and a memory module interface 495. The electronic device 102 may access the wireless network 101 via the memory module 490, which may include one or more physical universal integrated circuit cards (UICC), which may also be referred to as a subscriber identity module (SIM) card. The memory module 490 may be inserted in or connected to the memory module interface 495 of the electronic device 102.

The SIM card is an integrated circuit that includes a processor and memory, and may store unique equipment identifiers identifying the end-user of the electronic device 102 which may include a unique phone number and IMSI number, security keys, a subscription service package provided by the wireless service provider that define the communication services of the electronic device 102, etc. In at least some example embodiments, the SIM card may further store financial institution and financial instrument information (i.e. the SIM card may allow the electronic device 102 to function as a “mobile wallet”). This financial information may be sent from the electronic device 102 to a POS terminal via the short-range communication subsystem 482 (such as the NFC communication subsystem 484) during a mobile payment transaction. The SIM cards are provided by wireless network service providers to manage wireless network communication services for the electronic device 102. In some cases, the electronic device 102 may include an embedded SIM card that is not removable.

The electronic device 102 may store data 470 in a data area of the memory 450. The data 470 may be of various types and may include service data, application data, etc. In at least some example embodiments, the data may include a unique equipment identifier, such as an IMEI, associated with the electronic device 102.

The processor 440 may operate under stored program control and may execute software modules 460 stored on the memory 450. The software modules 460 may be comprised of, for example, operating system 462 software, and one or more additional modules such as a mobile wallet 464 to carry out specific functions of the electronic device 102.

The operating system 462 is software that manages the electronic device 102 components (such as the input interface 420, the output interface 422, the communication subsystem 480, etc.) and provides a platform for the software modules 460. The operating system 462 also acts as an intermediary between the electronic device 102 components and the software modules 460. For example, the operating system 462 may recognize data that is being input from an input device and route the inputted data to be executed by a software module 460. The operating system 462 may be Microsoft Windows OS™, iOS™, Linux™, UNIX™, Android™ or any other operating system 462 having the necessary capabilities for implementing the functions described herein.

The mobile wallet 464 is a module that manages mobile payments from the electronic device 102. That is, the mobile wallet 464 may provide an interface for performing mobile payments, and may coordinate communication between the electronic device 102 and other devices (such as the POS terminal 108) and/or servers (such as the merchant server (which may be referred to as a third party server 112), financial institution server 114 and/or wireless service provider server 116 during a mobile payment transaction). For example, the mobile wallet may retrieve and transfer financial information to a POS terminal 108 of a merchant via the short-range communication subsystem 482 (such as the NFC communication subsystem 484) when a mobile payment transaction is initiated, and may receive sales associated information from the POS terminal 108. Additionally, the mobile wallet 464 may retrieve and transfer the phone number and/or IMEI associated with the electronic device 102 to the financial institution server 114 as part of the mobile payment transaction. It will be appreciated that the mobile wallet 464 may receive and send other information to these devices and servers during the mobile payment transaction.

In at least some example embodiments, the mobile wallet 464 may be involved with the financial institution server 114 for further verification of the electronic device 102 by an end-user during a mobile payment transaction. In such example embodiments, the mobile wallet 464 may receive a request for verification of the electronic device 102 from the financial institution (as mentioned above, such a request may be initiated after the financial institution server 114 determines that the IMEI of the associated phone number of the electronic device 102 does not form a match). In such example embodiments, after receipt of the request for verification, the mobile wallet 464 may display the request for verification as a request for input on a display (not shown) of the electronic device 102. For example, one or more security questions or a password prompt may be displayed on the display. An end user may input answer(s) to the one or more security questions and/or a password to the password prompt, for example, via an input interface 420. Upon input of the answer(s) and/or password, they are received by the mobile wallet 464, and sent to the financial institution server 114 for further processing and verification of the electronic device 102.

It will be appreciated that, in at least some example embodiments, other modules, such as the operating system 462 may perform some or all of the functions of the mobile wallet 464. In at least some example embodiments, the mobile wallet 464 may instead include a plurality of software modules rather than a single block as illustrated.

### Verifying a Mobile Payment Transaction

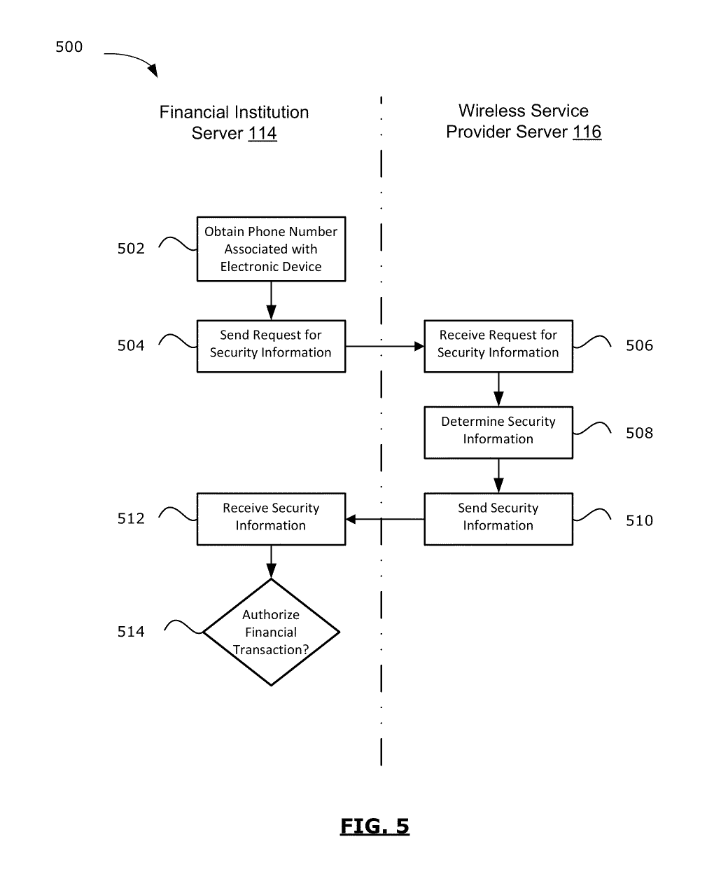

Referring now to FIG. 5, an example method 500 of verifying a mobile payment transaction is illustrated in flowchart form. Portions of the method 500 may be implemented by the financial institution server 114 and portions of the method 400 may be implemented by the wireless service provider server 116. One or more modules on the financial institution server 114, such as the verification module 264, may perform portions of the method 500 and one or more modules on the wireless service provider server 116, such as the retriever module 364, may perform portions of the method 500. More particularly, the verification module 264 may contain computer readable instructions causing the processor 240 associated with the financial institution server 114 to perform the functions that are indicated as being performed by the financial institution server 114. Similarly, the retriever module 364 may contain computer readable instructions causing the processor 340 associated with the wireless service provider server 116 to perform the wireless service provider server 116 specific operations. It will be appreciated that other modules on the financial institution server 114 or the wireless service provider server 116 may perform some or all of the device-specific operations of method 500.

The method 500 includes, at 502, the financial institution server 114 obtaining a phone number associated with the electronic device 102 involved in the financial transaction (i.e. the mobile payment transaction). The phone number is obtained from the electronic device 102 by the financial institution server 114. For example, the phone number may be requested and received by the financial institution server 114, or automatically sent by the electronic device 102 to the financial institution server 114 during the financial transaction. Other information, such as a unique equipment identifier associated with the electronic device 102, may also be obtained from the electronic device in some embodiments at 502.

At 504, the financial institution server 114 sends a request for security information associated with the electronic device 102 to the wireless service provider server 116. The request includes the obtained phone number associated with the electronic device 102 and, in some embodiments, may include the unique equipment identifier obtained from the electronic device.

At 506, the wireless service provider server 116 receives the sent request for security information associated with the electronic device 102 from the financial institution server 114.

In response to receiving the request, the wireless service provider server 116, at 508, determines the security information based on the received phone number associated with the electronic device 102. As mentioned above, the wireless service provider server 116 may store security information (for example in the data 370 area of memory 350) and/or may obtain such information by interacting (or attempting to interact) with the electronic device in response to receiving the request. In at least some example embodiments, the stored security information is arranged with each phone number being associated with respective security information which may include a unique equipment identifier (e.g. an IMEI) identifying an electronic device which is currently registered for use with the phone number on the wireless network or an operating state of the electronic device 102. Accordingly, the wireless service provider server 116 retrieves the security information of the associated received phone number which includes a unique equipment identifier or an operating state of the electronic device 102.

In some embodiments, the security information may not be retrieved from memory but may, instead, be generated in response to receiving the request for security information at 506. For example, as noted above, in some embodiments the security information may identify the operating state of the electronic device. In some such embodiments, in response to receiving the request, the wireless service provider server 116 may send a message to the electronic device 102 associated with the phone number specified in the request and may then determine whether the electronic device is in a switched-on or switched-off state based on the response. For example, the operating state of the electronic device 102 may be determined by the wireless service provider server 116 sending a short message service (SMS) communication to the electronic device 102. After the SMS is sent, the wireless service provider server 116 determines whether a delivery notification associated with the SMS is received within a pre-determined time from the electronic device 102. If the delivery notification is received within the pre-determined time, the operating state is a currently switched-on state of the electronic device 102; however, if the delivery notification is not received within the pre-determined time, the operating state is a currently switched-off state of the electronic device 102.

The retrieved (or otherwise obtained) security information is then sent by the wireless service provider server 116 to the financial institution server 114 at 510, and the sent security information is received by the financial institution server 114 at 512.

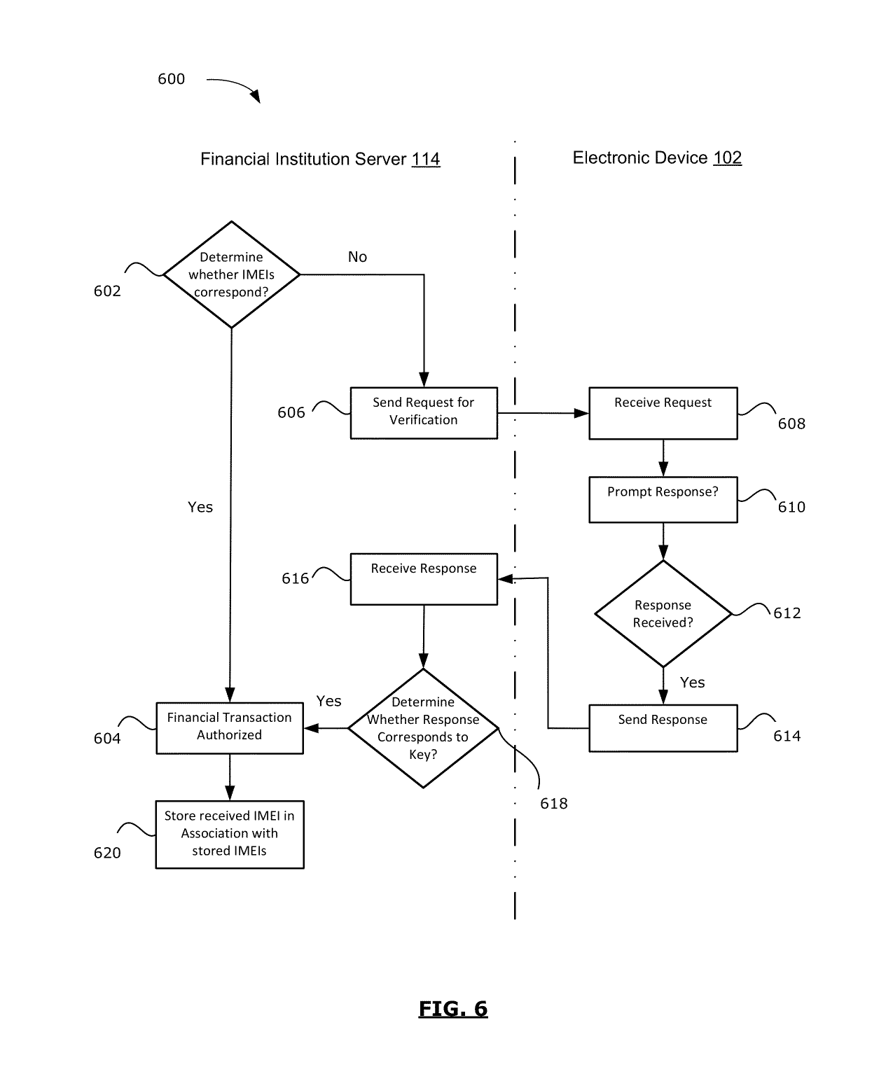

At 514, the financial institution server 114 then determinates whether the financial transaction is authorized based on the received security information. This determination process may be performed in various manners, and examples of such determination are described in greater detail below with reference to FIG. 6.

### Determining Whether to Authorize Mobile Payment Transaction

As mentioned above, as part of the financial transaction, after receiving security information, the financial institution server 114 may determine whether to authorize the financial transaction. Example embodiments of such determination are now described.

Referring now to FIG. 6, an example method 600 of determining whether to authorize a mobile payment transaction is illustrated in flowchart form. Portions of the method 600 may be implemented by the financial institution server 114 and portions of the method 400 may be implemented by the electronic device 102. One or more modules on the financial institution server 114, such as the verification module 264, may perform portions of the method 600 and one or more modules on the electronic device 102, such as the mobile wallet 464, may perform portions of the method 600. More particularly, the verification module 264 may contain computer readable instructions causing the processor 240 associated with the financial institution server 114 to perform the functions that are indicated as being performed by the financial institution server 114. Similarly, the mobile wallet 464 may contain computer readable instructions causing the processor 440 associated with the electronic device 102 to perform the electronic device 102 specific operations. It will be appreciated that other modules on the financial institution server 114 or the electronic device 102 may perform some or all of the device-specific operations of method 600.

In at least some example embodiments, the method 600 may be performed at 514 of method 500 of FIG. 5.

At 602, the financial institution server 114 may determine whether a unique equipment identifier received from the wireless service provider server 116 (for example, received at 512 of FIG. 5) corresponds to one of one or more stored historical unique equipment identifiers associated with the phone number received from the electronic device 102. The received unique equipment identifier identifies the electronic device that is currently registered in the wireless network for use with the phone number. As noted previously, the financial institution server 114 may store one or more unique equipment identifiers of electronic devices that were previously associated with the phone number and which have been previously verified to perform a financial transaction (i.e. a mobile payment transaction). That is, unique equipment identifiers of electronic devices 102 previously used for performing a financial transaction in association with the same phone number are examined. More particularly, in such example embodiments, the financial institution server 114 compares the unique equipment identifier received from the wireless service provider server 116 (which is an identifier of the electronic device currently registered for use with a specified phone number) to the historical unique equipment identifiers associated with the phone number to determine whether there is a match.

If there is a match, at 604, the financial institution server 114 authorizes the financial transaction. In such cases, the electronic device 102 being used to perform the financial transaction was previously verified and used to perform a financial transaction using the same associated phone number, and accordingly, the financial transaction is allowed to proceed.

However, if there is no match, at 606, the financial institution server 114 sends a request for verification of the electronic device 102 to the electronic device 102 (i.e. the financial institution server 114 requests further verification in order to authorize the financial transaction). The request for verification of the electronic device 102 may be in the form of one or more security questions and/or a password prompt that are sent to the electronic device 102.

The electronic device 102, at 608 receives the request for verification of the electronic device 102.

At 610, the electronic device 102 prompts a response to the received request for verification of the electronic device 102. For example, the electronic device 102 may display a request for a response of the one or more security questions and/or password prompt.

At 612, the electronic device 102 may receive a response to the prompt, for example, by a user inputting the response via an input interface (such as, a physical or virtual keyboard) associated with the electronic device 102.

After receiving the response, the electronic device 102, at 614, sends the response to the financial institution server 114, which is received by the financial institution server 114 at 616.

At 618, the financial institution server 114 determines whether the received response corresponds to a key associated with the request for verification (i.e. whether there is match between the two). For example, the financial institution server 114 determines whether the response to a sent security question matches its associated answer, and/or whether the response to a password prompt matches its associated password.

If there is a match, the financial transaction is authorized as in 604. However, if there is no match, the financial transaction may be declined.

In at least some example embodiments, at 620, the financial institution server 114 may store the received unique equipment identifier from the wireless service provider server 116 in association with the stored one or more historical unique equipment identifiers associated with the phone number of the electronic device 102. In such cases, as the electronic device 102 has been further verified, its associated unique equipment identifier may be added with the one or more stored historical unique equipment identifiers so that future financial transactions from the electronic device 102 using the associated phone number do not require further verification for authorization of the financial transaction.

As mentioned above, in at least some example embodiments, other types of analysis may be performed by the financial institution server 114 to determine whether to authorize the financial transaction.

For example, in at least some example embodiments, although the determination analysis (of whether to authorize a financial transaction) is based on unique equipment identifiers, the financial institution server 114, rather than comparing the received unique equipment identifier from the wireless service provider server 116 with the stored one or more historical unique equipment identifier, may obtain a unique equipment identifier associated with the electronic device 102 directly from the electronic device 102, and compare this obtained unique equipment identifier obtained from the electronic device 102 with the unique equipment identifier received from the wireless service provider server 116 (which may be provided by the wireless service provider server 116 in response receiving request for such information which specifies a phone number associated with the request).

In at least some example embodiments, the determination analysis is based on other factors. For example, as mentioned above, in at least some example embodiments, the determination analysis is based on verifying information. In such cases, the financial institution server may obtain a unique equipment identifier associated with the electronic device 102 from the electronic device 102; send this obtained unique equipment identifier to the wireless service provider server 116 (along with a phone number which may also be obtained from the electronic device); and receive verifying information indicating whether the unique equipment identifier that was obtained from the electronic device 102 corresponds to the unique equipment identifier associated with the phone number of the electronic device 102 (i.e. it determines if electronic device being used for a financial transaction which purports to be associated with a particular phone number is registered for use with that phone number in the wireless network provided by the wireless service provider). This verifying information is analyzed by the financial institution server 114 to determine whether to authorize the transaction (i.e. if there is a match, the financial transaction is authorized; while if there is not a match, further verification may be performed similar to 606 to 618 prior to authorizing the financial transaction).

In at least some example embodiments, the determination analysis is based on the operating state of the electronic device 102. In such cases, the financial institution server 114 determines whether to authorize the financial transaction based on a current operating state of the electronic device 102. For example, authorizing the financial transaction may be authorized if the operating state of the electronic device 102 is a currently switched-on state and declined if the operating state is a currently switch-off state.

It will be appreciated that the determination analysis may be based on further factors such as, whether the electronic device 102 is blacklisted, the geographic location of the electronic device 102 (i.e. a roaming status of the electronic device 102), etc. Additionally, these factors may be applied individually or in combination in any order as part of the determination analysis.

While the present disclosure is primarily described in terms of methods, a person of ordinary skill in the art will understand that the present disclosure is also directed to various apparatus, such as a server and/or an electronic device, including components for performing at least some of the aspects and features of the described methods, be it by way of hardware components, software or any combination of the two, or in any other manner. Moreover, an article of manufacture for use with the apparatus, such as a pre-recorded storage device or other similar computer readable medium including program instructions recorded thereon, or a computer data signal carrying computer readable program instructions may direct an apparatus to facilitate the practice of the described methods. It is understood that such apparatus, and articles of manufacture also come within the scope of the present disclosure.

While the methods have been described as occurring in a particular order, it will be appreciated by persons skilled in the art that some of the steps may be performed in a different order provided that the result of the changed order of any given step will not prevent or impair the occurrence of subsequent steps. Furthermore, some of the steps described above may be combined in other embodiments, and some of the steps described above may be separated into a number of sub-steps in other embodiments.

The various embodiments presented above are merely examples. Variations of the embodiments described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

What is claimed is:

1. A method implemented by a financial institution server for verifying security information associated with an electronic device during a financial transaction between the electronic device and the financial institution server, the method comprising:
sending a request for security information associated with the electronic device to a wireless service provider server, the request including a phone number associated with the electronic device;
receiving the security information from the wireless service provider server, the security information including at least a unique equipment identifier associated with the phone number or an operating state of the electronic device; and
determining whether the financial transaction is authorized based on the received security information.

2. The method of claim 1, wherein the financial institution server stores one or more historical unique equipment identifiers associated with the phone number, and wherein determining whether the financial transaction is authorized includes:
determining whether the received unique equipment identifier from the wireless service provider server corresponds to one of the stored one or more historical unique equipment identifiers associated with the phone number,
and wherein the financial transaction is authorized when the received unique equipment identifier from the wireless service provider server corresponds to one of the stored one or more historical unique equipment identifiers associated with the phone number.

3. The method of claim 2, wherein determining whether the financial transaction is authorized further includes:
sending a request for verification of the electronic device to the electronic device when the received unique equipment identifier from the wireless service provider server does not correspond to one of the stored one or more historical unique equipment identifiers associated with the phone number;
receiving a response to the request for verification from the electronic device; and
determining whether the received response corresponds to a key associated with the request for verification,
and wherein the financial transaction is authorized when the received response corresponds to the key associated with the request for verification.

4. The method of claim 3, wherein determining whether the financial transaction is authorized further includes:
storing the received unique equipment identifier from the wireless service provider server in association with the stored one or more historical unique equipment identifiers associated with the phone number when the received response corresponds to the key associated with the request for verification.

5. The method of claim 1, further comprising:
obtaining a unique equipment identifier associated with the electronic device from the electronic device, and wherein determining whether the financial transaction is authorized further includes:
determining whether the obtained unique equipment identifier associated with electronic device from the electronic device corresponds to the received unique equipment identifier from the wireless service provider server,
and wherein the financial transaction is authorized when the obtained unique equipment identifier associated with the electronic device from the electronic device corresponds to the received unique equipment identifier from the wireless service provider server.

6. The method of claim 5, wherein determining whether the financial transaction is authorized further includes:
sending a request for verification of the electronic device to the electronic device when the obtained unique equipment identifier associated with the electronic device from the electronic device does not correspond to the received unique equipment identifier from the wireless service provider server;
receiving a response to the request for verification from the electronic device; and
determining whether the received response corresponds to a key associated with the request for verification,
and wherein the financial transaction is authorized when the received response corresponds to the key associated with the request for verification.

7. The method of claim 1, further comprising:
obtaining a unique equipment identifier associated with the electronic device from the electronic device; and
sending the obtained unique equipment identifier associated with the electronic device from the electronic device to the wireless service provider server,
and wherein the security information includes verifying information indicating whether the obtained unique equipment identifier associated with the electronic device from the electronic device corresponds to the unique equipment identifier associated with the phone number.

8. The method of claim 1, wherein the financial transaction is authorized when the operating state is a currently switched-on state of the electronic device.

9. The method of claim 1, wherein the unique equipment identifier is an international mobile station equipment identity (IMEI).

10. A financial institution server for verifying security information associated with an electronic device during a financial transaction between the electronic device and the financial institution server, the financial institution server comprising:
a communication subsystem;
a memory; and
a processor coupled to the communication subsystem and the memory, the processor configured to:
send a request for security information associated with the electronic device to a wireless service provider server, the request includes a phone number associated with the electronic device;
receive the security information from the wireless service provider server, the security information includes at least a unique equipment identifier associated with the phone number or an operating state of the electronic device; and
determine whether the financial transaction is authorized based on the received security information.

11. The financial institution server of claim 10, wherein the financial institution server stores one or more historical unique equipment identifiers associated with the phone number, and wherein determining whether the financial transaction is authorized includes:
determining whether the received unique equipment identifier from the wireless service provider server corresponds to one of the stored one or more historical unique equipment identifiers associated with the phone number,
and wherein the financial transaction is authorized when the received unique equipment identifier from the wireless service provider server corresponds to one of the stored one or more historical unique equipment identifiers associated with the phone number.

12. The financial institution server of claim 11, wherein determining whether the financial transaction is authorized further includes:
sending a request for verification of the electronic device to the electronic device when the received unique equipment identifier from the wireless service provider server does not correspond to one of the stored one or more historical unique equipment identifiers associated with the phone number;
receiving a response to the request for verification from the electronic device; and
determining whether the received response corresponds to a key associated with the request for verification,
and wherein the financial transaction is authorized when the received response corresponds to the key associated with the request for verification.

13. The financial institution server of claim 12, wherein determining whether the financial transaction is authorized further includes:
storing the received unique equipment identifier from the wireless service provider server in association with the stored one or more historical unique equipment identifiers associated with the phone number when the received response corresponds to the key associated with the request for verification.

14. The financial institution server of claim 10, further configured to:
obtain a unique equipment identifier associated with the electronic device from the electronic device, and wherein determining whether the financial transaction is authorized further includes:
determining whether the obtained unique equipment identifier associated with the electronic device from the electronic device corresponds to the received unique equipment identifier from the wireless service provider server,
and wherein the financial transaction is authorized when the obtained unique equipment identifier associated with the electronic device from the electronic device corresponds to the received unique equipment identifier from the wireless service provider server.

15. The financial institution server of claim 14, wherein determining whether the financial transaction is authorized further includes:
sending a request for verification of the electronic device to the electronic device when the obtained unique equipment identifier associated with the electronic device from the electronic device does not correspond to the received unique equipment identifier from the wireless service provider server;
receiving a response to the request for verification from the electronic device; and
determining whether the received response corresponds to a key associated with the request for verification,
and wherein the financial transaction is authorized when the received response corresponds to the key associated with the request for verification.

16. The financial institution server of claim 10, further configured to:
obtain a unique equipment identifier associated with the electronic device from the electronic device; and
send the obtained unique equipment identifier associated with the electronic device from the electronic device to the wireless service provider server,
and wherein the security information includes verifying information indicating whether the obtained unique equipment identifier associated with the electronic device from the electronic device corresponds to the unique equipment identifier associated with the phone number.

17. The financial institution server of claim 10, wherein the financial transaction is authorized when the operating state is a currently switched-on state of the electronic device.

18. A method implemented by a wireless service provider server for providing security information associated with an electronic device during a financial transaction between the electronic device and a financial institution server, the method comprising:
receiving a request, from the financial institution server, for security information associated with the electronic device, the request including a phone number associated with the electronic device;
in response to receiving the request, determining the security information based on the phone number associated with the electronic device, the security information including at least a unique equipment identifier associated with the phone number or an operating state of the electronic device; and
sending the security information to the financial institution server.

19. The method of claim 18, further comprising:
receiving a unique equipment identifier associated with the electronic device from the financial institution server, and wherein determining the security information includes:
determining whether the received unique equipment identifier associated with the electronic device from the financial institution server corresponds to the unique equipment identifier associated with the phone number of the electronic device,
and wherein the security information includes verifying information indicating whether the received unique equipment identifier associated with electronic device from the financial institution server corresponds to the unique equipment identifier associated with the phone number of the electronic device.

20. The method of claim 18, wherein determining the security information includes:
sending a short message service communication to the electronic device; and
in response to sending the short message service communication, determining whether a delivery notification associated with the short message service communication is received within a pre-determined time from the electronic device,
and wherein the operating state is a currently switched-on state of the electronic device when the delivery notification is received within the pre-determined time, and wherein the operating state is a currently switched-off state of the electronic device when the delivery notification is not received within the pre-determined time.
